(19) United States
(12) Patent Application Publication
(10) Pub. No.: US 2015/0242130 A1
(43) Pub. Date: Aug. 27, 2015

(54) Multi-Threshold Storage Device and Method

(71) Applicant: National Chung Cheng University, Chia-Yi (TW)

(72) Inventors: Rong-Guey CHANG, Chiayi County (TW); Chia-Jung CHEN, Kaohsiung City (TW)

(73) Assignee: National Chung Cheng University, Chia-Yi (TW)

(21) Appl. No.: 14/292,577

(22) Filed: May 30, 2014

(30) Foreign Application Priority Data
Feb. 27, 2014 (TW) 103106712

(51) Int. Cl. G06F 3/06

(52) U.S. Cl. CPC G06F 3/0611; G06F 3/0643; G06F 3/0659; G06F 3/0685; G06F 2003/0692

(57) ABSTRACT

A multi-threshold storage device and method is disclosed herein. The device comprises at least one hard disc drive (HDD), at least one solid state drive (SSD), and a controller electrically connected with HDD and SSD. The controller determines whether to store a file in HDD or SSD according to whether the read/write (r/w) count of the file exceeds a preset r/w count, whether the storage space occupied by the file exceeds a preset storage space, and whether the file is a popular file. The present invention uses multiple thresholds to configure storage positions of files, improve the economical efficiency of file storage and raise the overall performance of a server system.

This application claims priority for Taiwan patent application no. 103106712 filed at Feb. 27, 2014, the content of which is incorporated by reference in its entirely.

### BACKGROUND OF THE INVENTION

1. Field of the Invention

The present invention relates to a storage device applied to recording multimedia and video data, particularly to a multi-threshold storage device and method using multiple thresholds to configure storage positions of files.

2. Description of the Related Art

With popularization of community websites and video websites, images and videos are massively transmitted, displayed and shared on line. Meanwhile, the hardware thereof has also advanced greatly. Persistent hardware advance provides higher and higher image resolution, and users' requirement for image quality has been beyond the so-called viewability. The higher the resolution, the greater the file size, and the slower the data accessing. The conventional data access technology is no more able to access high-resolution video files satisfactorily. Thus, there are innovative storage devices developed to solve the problem.

Hard disc drives (HDD) are the hardware frequently used for data storage traditionally. HDD has a high capacity cost rate, but it is hard to deal with the current massive data streams. Compared with HDD, solid state drives (SSD) exhibit higher efficiency in data accessing. However, SSD has a shorter service life and a lower capacity cost rate.

It is well known in multimedia application: popular files are accessed frequently. In the conventional technology, frequently accessed files are placed in SSD, and non-frequently accessed files are placed in HDD. Although a single SSD access activity can only improve performance to a very limited extent, multitudinous SSD access activities would greatly promote operation efficiency and obviously reduce data accessing time. However, some factors should be further considered in using SSD, such as the size of a file. Too large a file would consume a great amount of storage space of SSD and raise the hardware cost. Appropriate integration of HDD and SSD should be able to achieve optimized operation performance and economical efficiency.

Accordingly, the present invention proposes a multi-threshold storage device and method to overcome the abovementioned problems.

### SUMMARY OF THE INVENTION

The primary objective of the present invention is to provide a multi-threshold storage device and method, wherein multiple thresholds are used to configure storage positions of files, improve the economical efficiency of file storage and raise the overall performance of a server system.

Another objective of the present invention is to provide a multi-threshold storage device and method, which uses 8 eigenvalues of a file to determine whether the file is placed in a hard disc drive or a solid state drive.

To achieve the abovementioned objectives, the present invention proposes a multi-threshold storage device, which comprises at least one hard disc drive (HDD), at least one solid state drive (SSD), and a controller electrically connected with HDD and SSD. The controller examines whether the read/write (r/w) count of a file exceeds a preset r/w count, whether the storage space occupied by the file exceeds a preset storage space and whether the file is a popular file to determine whether the file is stored in HHD or SSD. Suppose the following three conditions are simultaneously satisfied: the r/w count of the file exceeds the preset r/w count; the storage space occupied by the file does not exceed a preset storage space; and the file is a popular file. In such a case, the controller places the file in SSD. Suppose one or more of the following three conditions are satisfied: the r/w count of the file does not exceed the preset r/w count; the storage space occupied by the file exceeds a preset storage space; and the file is not a popular file. In such a case, the controller places the file in HDD.

The present invention also proposes a multi-threshold storage method, which comprises steps: acquiring at least one file; examining whether the r/w count of the file exceeds a preset r/w count; if not, placing the file in HDD; if yes, examining whether the storage space occupied by the file exceeds a preset storage space; if yes, placing the file in HDD; if not, examining whether the file is a popular file; if not, placing the file in HDD; if yes, placing the file in SSD.

Below, embodiments are described in detail to make easily understood the objectives, technical contents, characteristics and accomplishments of the present invention.

### BRIEF DESCRIPTION OF THE DRAWINGS

FIG. 1 is a block diagram schematically showing the architecture of a multi-threshold storage device according to one embodiment of the present invention;

FIG. 2 shows a flowchart of a multi-threshold storage method according to one embodiment of the present invention; and

FIG. 3 shows 8 eigenvalues for determining file placement according to one embodiment of the present invention.

### DETAILED DESCRIPTION OF THE INVENTION

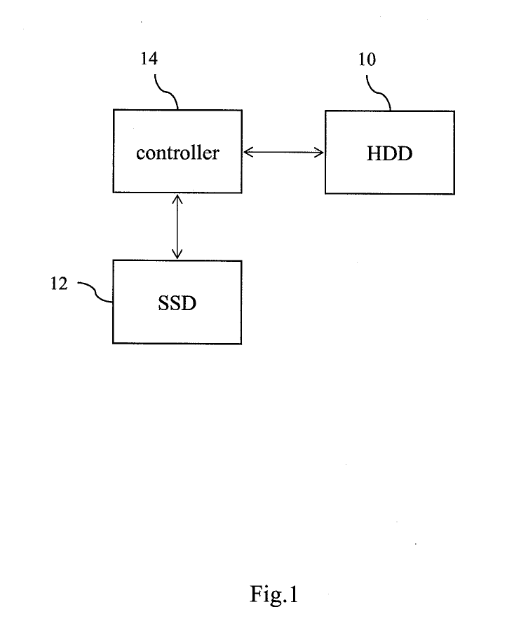

Refer to FIG. 1 for a block diagram schematically showing the architecture of a multi-threshold storage device according to one embodiment of the present invention. The multi-threshold storage device of the present invention comprises at least one hard disc drive 10 (HDD); at least one solid state drive 12 (SSD); and a controller 14. The controller 14 is electrically connected with HDD 10 and SSD 12 and able to read the filename of a file. The controller 14 examines whether the read/write (r/w) count of a file exceeds a preset r/w count, whether the storage space occupied by the file exceeds a preset storage space and whether the file is a popular file to determine whether the file is stored in HHD 10 or SSD 12. Suppose the following three conditions are simultaneously satisfied: the r/w count of the file exceeds the preset r/w count; the storage space occupied by the file does not exceed a preset storage space; and the file is a popular file. In such a case, the controller 14 places the file in SSD 12. Suppose one or more of the following three conditions are satisfied: the r/w count of the file does not exceed the preset r/w count; the storage space occupied by the file exceeds a preset storage space; and the file is not a popular file. In such a case, the controller 14 places the file in HDD 10.

The controller 14 determines whether a file is a popular file according to the r/w count of the file. If the r/w count of a file is smaller, the controller 14 determines that the file is an uncommon file, i.e. an unpopular file. In such a case, the controller 14 places the file in HDD 10. If the r/w count of a file is greater, the controller 14 determines that the file is a popular file and places the file in SSD 12. However, if the r/w count of the file decreases, the controller 14 moves the file from SSD 12 to HDD 10.

Besides, the controller 14 has a priority list recording the priorities for storing files in SSD 12. The priority of a file is determined according to the read timing and the write timing of the file. The controller 14 examines whether and when a file has been read or written before. The later a file was read, the higher the priority to store the file in SSD. The controller 14 stores the files having higher priorities in SSD 12 to enable the higher-priority files to be read faster by users. The controller 14 stores the files having lower priorities in HDD 10 and retrieves them when necessary.

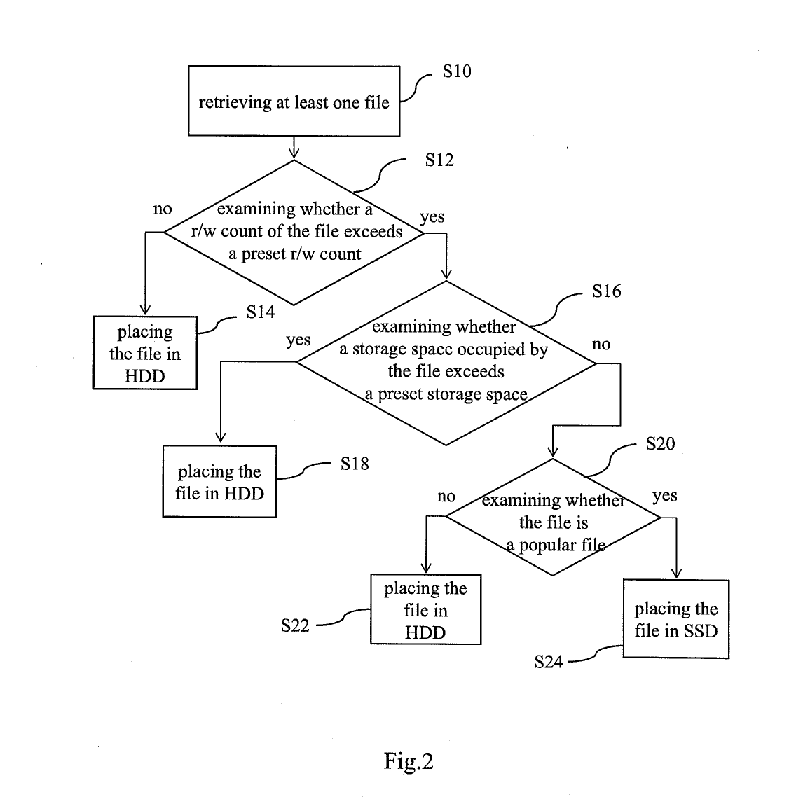

The architecture of a multi-threshold storage device of the present invention has been described above, and the process of a multi-threshold storage method will be described below. Refer to FIG. 1 and FIG. 2. FIG. 2 shows a flowchart of a multi-threshold storage method according to one embodiment of the present invention. In Step S 10, the controller 14 retrieves a file and acquires the filename of the file. In Step S12, the controller 14 examines whether the r/w count of the file exceeds a preset r/w count. If the r/w count of the file does not exceed the preset r/w count, the process proceeds to Step S14. In Step S14, the controller 14 places the file in HDD 10. If the r/w count of the file exceeds the preset r/w count, the process proceeds to Step S16. In Step S16, the controller 14 examines whether the storage space occupied by the file exceeds a preset storage space. If the storage space occupied by the file exceeds the preset storage space, the process proceeds to Step S18. In Step S18, the controller 14 places the file in HDD 10. If the storage space occupied by the file does not exceed the preset storage space, the process proceeds to Step S20. In Step S20, the controller 14 examines whether the file is a popular file. If the file is not a popular file, the process proceeds to Step S22. In Step S22, the controller 14 places the file in HDD 10. If the file is a popular file, the process proceeds to Step S24. In Step S24, the controller 14 places the file in SSD 12.

After files have been placed in HDD or SSD, the controller 14 further examines the priorities for storing the files in SSD. The priority of a file is determined according to the read timing and the write timing of the file. The controller 14 examines whether and when a file has been read or written before. The later a file was read, the higher the priority to store the file in SSD. The controller 14 stores the files having higher priorities in SSD 12 to enable the higher-priority files to be read faster by users. The controller 14 stores the files having lower priorities in HDD 10 and retrieves them when necessary.

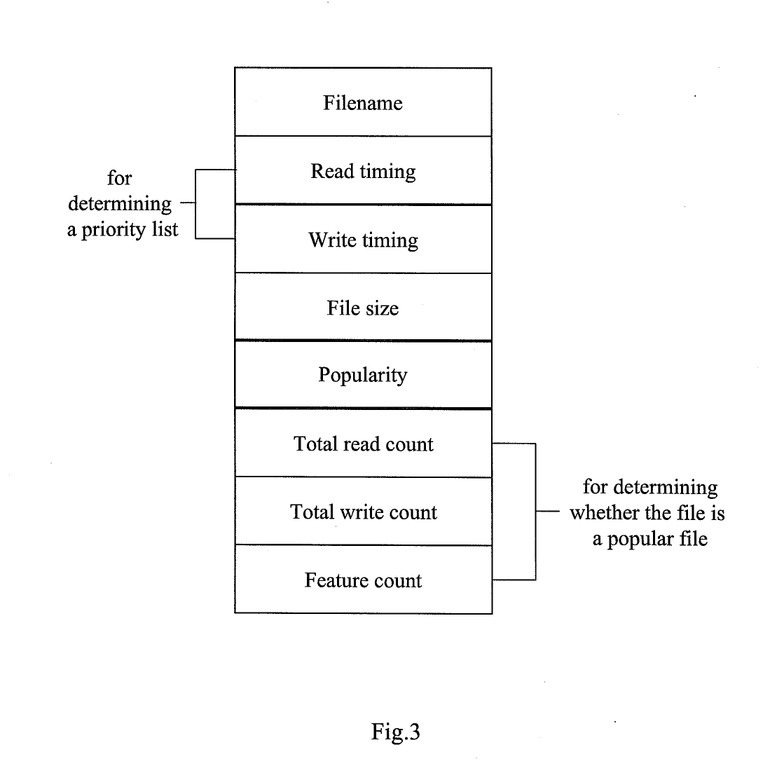

From the above description, it is learned that present invention places a file in HDD 10 or SSD 12 according to 8 eigenvalues. Refer to FIGS. 1-3. FIG. 3 shows 8 eigenvalues of a file according to one embodiment of the present invention. The 8 eigenvalues used in the present invention include filename, read timing, write timing, file size, popularity, total read count, total write count, and feature count. In Step S12, after having acquiring the filename of a file, the controller 14 examines whether the r/w count of the file exceeds a preset r/w count. The r/w count of the file is determined by the total read count, the total write count and feature count of the file. In Step S16, the storage space occupied by a file is determined by one of the 8 eigenvalues—the file size. In Step S20, the popularity of a file is determined by the sum of the total read count and the total write count of the file. The priority for storing a file in SSD is determined by the read timing and the write timing of the file. Therefore, the present invention places a file in HDD 10 or SSD 12 according to the 8 eigenvalues shown in FIG. 3, including filename, read timing, write timing, file size, popularity, total read count, total write count, and feature count.

In conclusion, the present invention allocates files to HHD or SSD according to multiple thresholds including 8 eigenvalues, improving the economical efficiency of file storage and raising the overall performance of a server system.

The embodiments described above are only to exemplify the present invention but not to limit the scope of the present invention. Any equivalent modification or variation according to the spirit or characteristic of the present invention is to be also included within the scope of the present invention.

What is claimed is:

1. A multi-threshold storage device comprising
at least one hard disc drive (HDD);
at least one solid state drive (SSD) electrically connected with said HDD; and
a controller electrically connected with said HDD and said SSD and determining whether to place said file in HHD or SSD according to whether a read/write (r/w) count of a file exceeds a preset r/w count, whether a storage space occupied by said file exceeds a preset storage space and whether said file is a popular file, wherein said controller places said file in said SSD if three conditions are simultaneously satisfied: said r/w count of said file exceeds said preset r/w count; said storage space occupied by said file does not exceed said preset storage space; and said file is a popular file, and wherein said controller places said file in said HDD if one or more of three conditions are satisfied: said r/w count of said file does not exceed said preset r/w count; said storage space occupied by said file exceeds said preset storage space; and said file is not a popular file.

2. The multi-threshold storage device according to claim 1, wherein said controller can acquire a filename of said file.

3. The multi-threshold storage device according to claim 1, wherein whether said file is a popular file is determined by said r/w count of said file, and wherein said file is determined to be a popular file if said r/w count of said file is higher.

4. The multi-threshold storage device according to claim 1, wherein said controller moves said popular file to said HDD if said r/w count of said popular file decreases.

5. The multi-threshold storage device according to claim 1, wherein said controller has a priority list recording priorities for placing files in said SSD, and wherein a file read later has a higher priority and will be placed in said SSD preferentially.

6. The multi-threshold storage device according to claim 5, wherein said priority for placing a file in said SSD is determined by a read timing of said file and a write timing of said file.

7. The multi-threshold storage device according to claim 1, wherein said r/w count of a file is determined by a total read count of said file, a total write count of said file, and a feature count of said file.

8. A multi-threshold storage method comprising
Step (A): retrieving at least one file;
Step (B): examining whether a read/write (r/w) count of said file exceeds a preset r/w count;
if said r/w count of said file does not exceed said preset r/w count, placing said file in a hard disc drive (HDD); and
if said r/w count of said file exceeds said preset r/w count, undertaking a next step;
Step (C): examining whether a storage space occupied by said file exceeds a preset storage space;
if said storage space occupied by said file exceeds said preset storage space, placing said file in said HDD; and
if said storage space occupied by said file does not exceed said preset storage space, undertaking a next step; and
Step (D): examining whether said file is a popular file;
if said file is not a popular file, placing said file in said HDD; and
if said file is a popular file, placing said file in a solid state drive (SSD).

9. The multi-threshold storage method according to claim 8, wherein retrieving at least one file includes acquiring a filename of said file.

10. The multi-threshold storage method according to claim 8, wherein in said Step (D), whether said file is a popular file is determined by said r/w count of said file, and wherein said file is determined to be a popular file if said r/w count of said file is higher.

11. The multi-threshold storage method according to claim 8, wherein said popular file is moved to said HDD if said r/w count of said popular file decreases.

12. The multi-threshold storage method according to claim 8 further comprising a step of establishing a priority list recording priorities for placing files in said SSD, wherein a file read later has a higher priority and will be placed in said SSD preferentially.

13. The multi-threshold storage method according to claim 12, wherein said priority for placing a file in said SSD is determined by a read timing of said file and a write timing of said file.

14. The multi-threshold storage method according to claim 8, wherein said r/w count of a file is determined by a total read count of said file, a total write count of said file, and a feature count of said file.
